(19) United States
(12) Patent Application Publication
(10) Pub. No.: US 2016/0256888 A1
(43) Pub. Date: Sep. 8, 2016

(54) JETTING DEVICE

(71) Applicant: OCE-TECHNOLOGIES B.V., Venlo (NL)

(72) Inventors: Mircea V. RASA, Venlo (NL); Cornelis J. GROENENBERG, Venlo (NL)

(73) Assignee: OCE-TECHNOLOGIES B.V., Venlo (NL)

(21) Appl. No.: 15/045,973

(22) Filed: Feb. 17, 2016

(30) Foreign Application Priority Data
Mar. 3, 2015 (EP) 15157395.3

(51) Int. Cl. B05B 17/06; B05B 1/08

(52) U.S. Cl. CPC B05B 17/0653; B05B 1/08

(57) ABSTRACT

A jetting device comprising:
a fluid chamber connected to a nozzle and containing a fluid to be jetted, and an electrically conductive medium;
a magnetic field source arranged to create a magnetic field in the electrically conductive medium;
a pair of electrodes contacting the electrically conductive medium; and
a controller arranged to control a flow of an electric current through the electrodes and the electrically conductive medium,
   characterized in that the pair of electrodes is configured to constitute a sonode for generating an ultrasonic acoustic wave in the electrically conductive medium, and the controller is arranged to activate the sonode during a time at which the jetting device does not perform a jetting operation.

The invention relates to a jetting device comprising:
a fluid chamber connected to a nozzle and containing a fluid to be jetted and an electrically conductive medium;
a magnetic field source arranged to create a magnetic field in the electrically conductive medium;
a pair of electrodes contacting the electrically conductive medium; and
a controller arranged to control a flow of an electric current through the electrodes and the electrically conductive medium.

WO 2010/063576 A1 discloses a jetting device of this type which is used for jetting molten metal such as copper, silver, gold, and the like. In this case, the electrically conductive medium is identical with the fluid to be jetted. The magnetic field source creates a magnetic field that extends at right angles to a flow direction of the fluid when the fluid flows to the nozzle. The electrodes are arranged to create an electric current that is normal to both the magnetic field and the flow direction of the fluid. As a consequence, the electrically conductive fluid is subject to a Lorentz force that accelerates the fluid towards the nozzle, so that, when the electric current is applied in the form of a pulse sequence, droplets of the molten metal are jetted out from the nozzle.

WO 2012/059322 A1 discloses an example where the fluid to be jetted is not electrically conductive. In that case, the fluid chamber contains two different fluids, one being the electrically conductive medium and the other one being the fluid to be jetted. The Lorentz force acts upon the electrically conductive medium and creates a pressure wave in that medium. The fluid to be jetted is in contact with the electrically conductive medium, so that the pressure wave propagates into the fluid to be jetted and causes the same to be jetted out from the nozzle.

When the fluid to be jetted is a molten metal, impurities may be present. These impurities may segregate from the molten, even if the impurities are present in only very small amounts. The impurities segregated from the molten metal may solidify in the nozzle, so that the nozzle tends to be clogged or at least to be obstructed so that the droplets are not formed and expelled as desired.

WO 2014/111213 A2 discloses a soldering nozzle wherein a sonode is immersed into the molten solder for creating an ultrasonic wave for removing impurities from the nozzle.

WO 2013/050250 A1 discloses a jetting device of the type described in the opening paragraph, wherein the electric current is modulated to form an alternating sequence of jetting pulses and maintenance pulses. The maintenance pulses have a similar duration as the jetting pulses but have a lower or preferably even negative amplitude and serve for agitating the fluid so as to improve the jetting stability.

It is an object of the invention to provide a jetting device that has a simple construction and is capable of keeping the fluid and the nozzle in a condition ready to operate during time periods where no droplets are jetted out.

In order to achieve this object, the pair of electrodes is configured to constitute a sonode for generating an ultrasonic acoustic wave in the electrically conductive medium, and the controller is arranged to activate the sonode during a time at which the jetting devices does not perform a jetting operation.

The ultrasonic wave created by the sonode keeps the fluid agitated and keeps any impurities that might be contained in the fluid in a finely dispersed state, so that the nozzle is prevented from becoming clogged and/or from reaching a condition in which the droplet generation and jetting behavior is degraded, even when the jetting device is not operating for a period of time that may be significantly larger than the droplet generation period.

As the sonode is constituted by one or both of the electrodes which are needed anyway for creating the electric current, the device can have a simple construction, and the fluid to be jetted does not have to come into contact with any other materials than the electrodes and the walls of the fluid chamber.

More specific optional features of the invention are indicated in the dependent claims. The frequency of the ultrasonic wave will normally be significantly higher than the jetting frequency of the device. For example, whereas the droplets are generated at a frequency of 500 to 2000 Hz, the frequency of the ultrasonic wave may be in the order of magnitude of several MHz, so that the ultrasonic frequency will be at least ten times, preferably at least 100 times and more preferably at least 1000 times larger than the jetting frequency.

The ultrasonic wave will be generated in particular in those time periods in which no jetting pulses are generated. Optionally, however, short ultrasonic pulses may also be applied in the gaps between the jetting pulses. On the other hand, when the ultrasonic wave is switched off shortly before and during the jetting pulses, any interference of the jetting pulses with the ultrasonic wave can be avoided.

In one embodiment, at least one of the electrodes is mechanically connected to or incorporates a vibrator, e.g. an electromechanical transducer for generating the ultrasonic wave. As the electrodes are arranged to contact the fluid to be jetted in the vicinity of the nozzle, the ultrasonic wave will readily propagate into the fluid and also into the fluid volume that fills the nozzle.

Optionally, an acoustic insulator, e.g. in the form of an elastic material, may be provided around the electrode that constitutes the sonode, in order to reduce the leakage of acoustic energy into the walls of the fluid chamber. For example, the acoustic insulator may be formed by leaving a narrow gap between the electrode and the walls of a passage through which the electrode enters into the fluid chamber, the width of the gap being so small, however, that capillary forces prevent the fluid from leaking out.

In another embodiment, the Lorentz force created by the magnetic field and the electric current may also be utilized for exciting the supersonic wave, in which case the sonode is formed by both electrodes and the volume of the electrically conductive medium through which the current flows. In that case, a mechanical or electro-mechanical transducer or vibrator may be dispensed with, and it is sufficient to provide a high-frequency electric oscillator which may be incorporated in the controller and is capable of creating a high-frequency current flowing through the electrodes and the medium. This high-frequency current may be an alternating current or a superposition of an alternating current and a direct current.

Preferably, the amplitude of the ultrasonic wave is controlled such that it does not cause the fluid to leak out through the nozzle.

Embodiment examples will now be described in conjunction with the drawings, wherein:

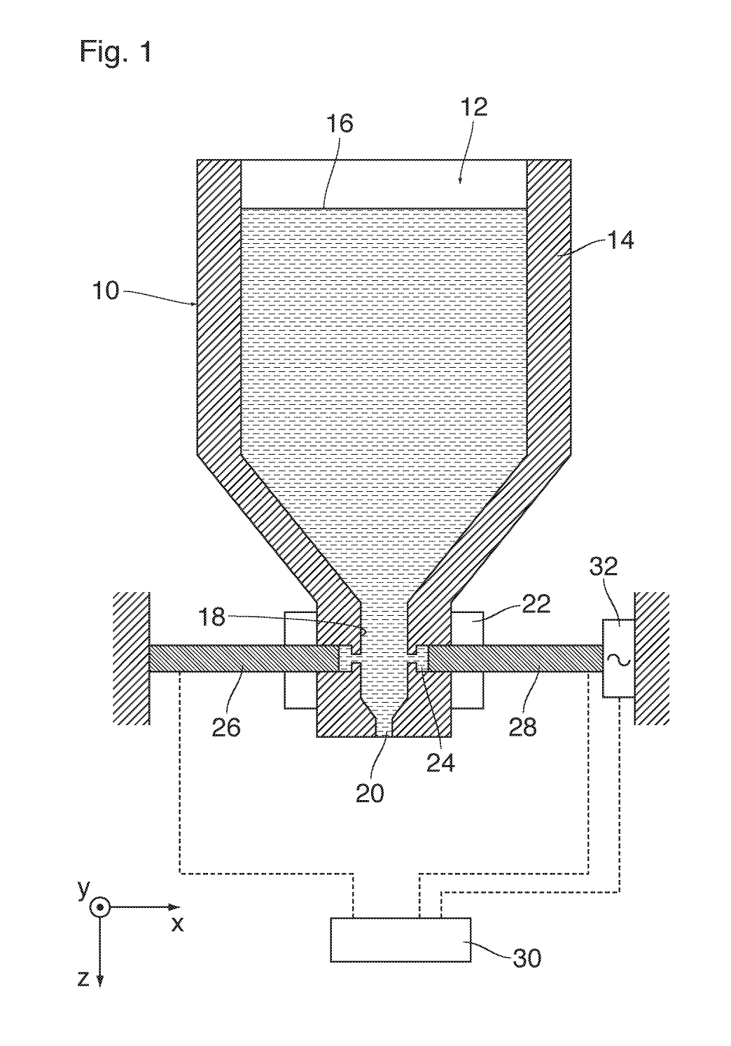

FIG. 1 is a schematic cross-sectional view of a jetting device according to an embodiment of the invention;

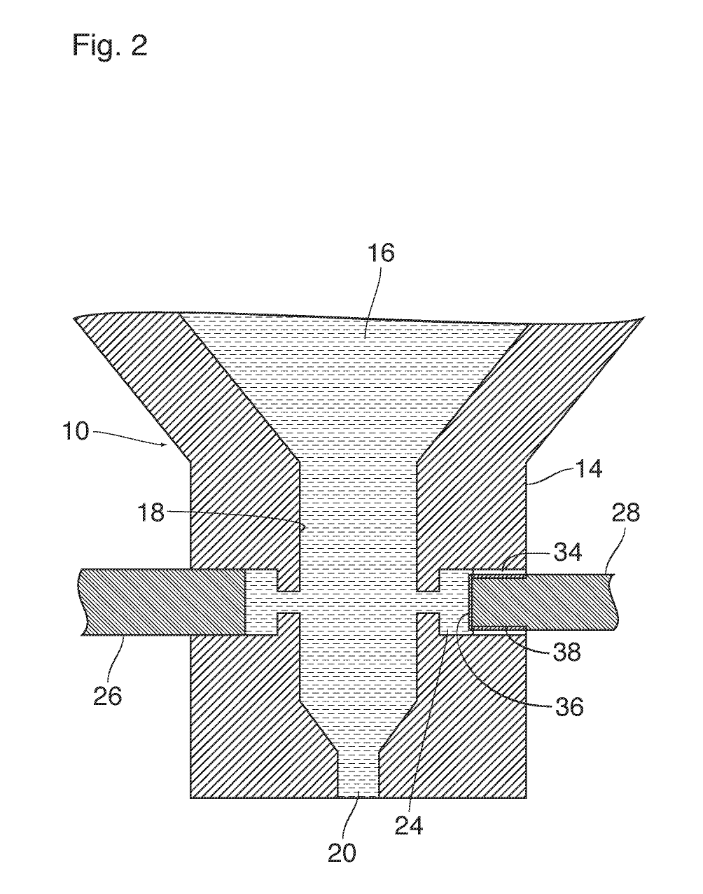

FIG. 2 shows an enlarged detail of FIG. 1; and

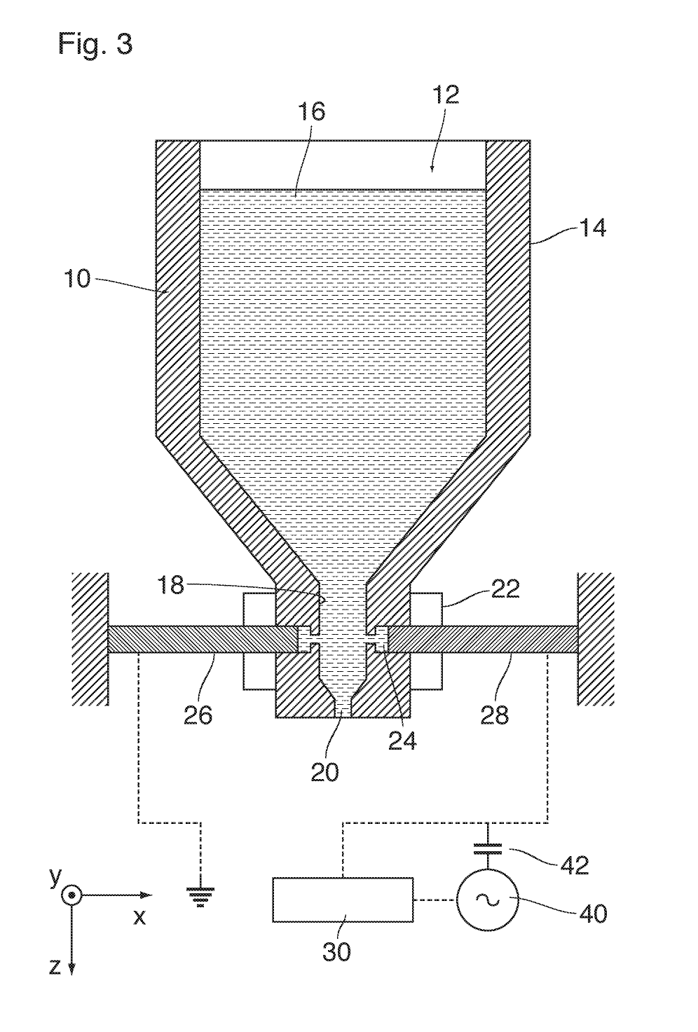

FIG. 3 is a schematic cross-sectional view of a jetting device according to a modified embodiment.

The jetting device shown in FIG. 1 has a fluid chamber body 10 defining a fluid chamber 12 that is surrounded by a thermally insulating wall 14. The fluid chamber 12 contains a fluid 16 which, in this example, is a molten metal such as copper, silver or gold. Thus, in this example, the fluid 16 is electrically conductive and constitutes an electrically conductive medium. The molten metal is kept at a temperature above its melting point by means of a well-known inductive heating, for example, which has not been shown here.

The fluid chamber 12 is shaped as a funnel that tapers towards a vertical passage 18 that ends in a nozzle 20 at the bottom end.

A magnetic field source 22 is formed by two permanently magnetized ferromagnetic bodies which are disposed before and behind the passage 18 in FIG. 1, so that only one of the two ferromagnetic bodies is visible in FIG. 1. It will be noted that the magnetic field source 22 is disposed outside of the thermally insulating wall 14 so that the temperature of the ferromagnetic bodies can be kept below the Curie point. The magnetic field source 22 creates a magnetic field that passes through the medium in the passage 18 in a direction y normal to the plane of the drawing in FIG. 1 and, consequently, normal to a direction z in which the fluid 16 can flow towards the nozzle 20.

A cross-passage 24 passes through the part of the wall 14 that delimits the vertical passage 18 in a direction x normal to the directions y and z and crosses the passage 18. Both ends of the cross-passage 24 are plugged by a respective electrode 26, 28 which is electrically connected to a controller 30. Since the fluid 16 is electrically conductive and the tip ends of the electrodes 26, 28 are in contact with this medium, an electric current can be caused to flow through the fluid 16 in the direction x. As a consequence, the electrically charged ions and electrons that constitute the medium 16 and the movement of which constitutes the electric current are subject to a Lorentz force that is normal to the direction x of the current and also normal to the direction y of the magnetic field, so that, by creating a current pulse with suitable polarity under the control of the controller 30, the medium 16 can be caused to flow in the direction z, i.e. in the direction of the nozzle 20, so that a droplet of the fluid will be jetted out.

The distal end of the electrode 28 is mechanically connected to a vibrator 32, e.g. an electro-mechanical transducer which is controlled by the controller 30 and capable of generating an acoustic wave with a frequency in the order of magnitude of several MHz. The vibrator 32 will be activated in particular in those periods, in which the jetting device is not operating and the controller 30 does not produce any jetting pulses, but the molten metal is still held in the fluid chamber 12, so that the jetting operation may be resumed at any time. The ultrasonic acoustic wave generated by the vibrator 32 will propagate towards the tip end of the electrode 28 and then into the fluid 16, so that the entire volume of the fluid 16 in the fluid chamber 12 and, in particular, in the passage 18 and the nozzle 20 will be agitated. The ultrasonic wave will be reflected at the opposite electrode 26 and at the wall 14 of the fluid chamber, so that a sort of three-dimensional standing wave pattern will be excited in the fluid. The sonic speed in the molten metal will be in the order of magnitude of 3000 or 3500 m/s, for example, so that the wavelength of the ultrasonic wave will be in the order of magnitude of 0.5 mm, typically a bit larger then but still in the same order of magnitude as the diameter of the nozzle 20. The amplitude (acoustic pressure) of the supersonic wave may be in the order of magnitude of 10⁸ Pa, for example. This agitation of the fluid 16 will hold any contaminants that might be contained in the fluid in a finely dispersed state and will in particular prevent such contaminants from segregating in the nozzle 20. In this way, the nozzle will be kept free and unobstructed, so that the jetting stability is maintained even in periods in which the operation of the jetting device is paused.

FIG. 2 is an enlarged detail of FIG. 1 showing that the electrode 28 that serves as a sonode is separated from the peripheral wall of the cross-passage 24 by an annular gap that serves as an acoustic insulator 34 for suppressing leakage of the supersonic wave into the wall 14 of the fluid chamber.

In order to assure intimate contact between the electrode 28 and the fluid 16, the tip end of the electrode 28 has a coating 36 that is readily wetted by the fluid 16. On the other hand, the adjacent part of the peripheral wall of the electrode 28 has an anti-wetting coating 38 assuring that capillary forces prevent the fluid 16 from leaking out through the gap forming the acoustic insulator 34.

FIG. 3 illustrates a modified embodiment in which the electrode 28 is not provided with a vibrator. Instead, this electrode is connected to an electronic oscillator 40 which generates an oscillating current with the desired frequency of the ultrasonic wave, e.g. 5 MHz.

The controller 30 is connected to the electrode 28 for applying the jetting pulses when the jetting device is operating, whereas the other electrode 26 is grounded. The controller 30 also controls the oscillator 40 so that the oscillating current is generated when the jetting device is not operating. A capacitor 42 shields the oscillator 40 from the low-frequency jetting pulses.

In this embodiment, the Lorentz force created by the oscillating current of the oscillator 40 in co-operation with the magnetic field serves to excite the ultrasonic wave directly in the fluid 16.

1. A jetting device comprising:
a fluid chamber connected to a nozzle and containing a fluid to be jetted, and an electrically conductive medium;
a magnetic field source arranged to create a magnetic field in the electrically conductive medium;
a pair of electrodes contacting the electrically conductive medium; and
a controller arranged to control a flow of an electric current through the electrodes and the electrically conductive medium,
wherein the pair of electrodes is configured to constitute a sonode for generating an ultrasonic acoustic wave in the electrically conductive medium, and the controller is arranged to activate the sonode during a time at which the jetting device does not perform a jetting operation.

2. The jetting device according to claim 1, wherein the controller is arranged to generate jetting pulses which have a certain jetting frequency, and the ultrasonic acoustic wave has a frequency that is at least ten times higher than the jetting frequency.

3. The jetting device according to claim 2, wherein the ultrasonic acoustic wave has a frequency of at least 500 kHz.

4. The jetting device according to claim 1, wherein at least one of the electrodes is mechanically connected to or has incorporated a vibrator for forming the sonode.

5. The jetting device according to claim 4, wherein the electrode that is associated with the vibrator passes through a wall of the fluid chamber and is separated from that wall by an acoustic insulator.

6. The jetting device according to claim 5, wherein the insulator is formed by an annular gap surrounding the part of the electrode that passes through the wall of the fluid chamber, and a peripheral surface of that part of the electrode has a surface that is non-wetting in relation to the fluid.

7. The jetting device according to claim 5, wherein the electrode that is associated with the vibrator has a tip that is in contact with the fluid and is adapted to be wetted by that fluid.

8. The jetting device according to claim 6, wherein the electrode that is associated with the vibrator has a tip that is in contact with the fluid and is adapted to be wetted by that fluid.

9. The jetting device according to claim 1, wherein an electronic oscillator is provided for passing an oscillating current through the electrodes and the sonode is formed by both electrodes and a part of the electrically conductive medium through which the oscillating current flows.
